(19) United States
(12) Patent Application Publication
(10) Pub. No.: US 2024/0036816 A1
(43) Pub. Date: Feb. 1, 2024

(54) SYSTEMS AND METHODS FOR IDENTIFYING SCALING FACTORS FOR DEEP NEURAL NETWORKS

(71) Applicant: TEXAS INSTRUMENTS INCORPORATED, Dallas, TX (US)

(72) Inventors: Kumar Desappan, Bangalore (IN); Anshu Jain, Bangalore (IN); Manu Mathew, Bangalore (IN)

(21) Appl. No.: 18/193,396

(22) Filed: Mar. 30, 2023

Related U.S. Application Data
(60) Provisional application No. 63/393,444, filed on Jul. 29, 2022.

(51) Int. Cl. G06F 5/01; G06F 7/485

(52) U.S. Cl. CPC G06F 5/012; G06F 7/485

(57) ABSTRACT

Disclosed herein are systems and methods for determining the scaling factors for a neural network that satisfy the activation functions employed by the nodes of the network. A processor identifies a saturation point of an activation function. Next, the processor determines a scaling factor for an output feature map based on the saturation point of the activation function. Then, the processor determines a scaling factor for an accumulator based on the scaling for the output feature map and further based on a shift value related to a quantization. Finally, the processor determines a scaling factor for a weight map based on the scaling factor for the accumulator.

### RELATED APPLICATIONS

This application is related to, and claims the benefit of priority to, U.S. Provisional Patent Application No. 63/393,444, filed on Jul. 29, 2022, and entitled “Method to Handle ReLU6 Activation in Neural Network with Regular Data Type Specific Saturation”, which is hereby incorporated by reference in its entirety.

### TECHNICAL FIELD

Aspects of the disclosure are related to the field of computing hardware and software and more particularly to identifying scaling factors for use in deep neural networks.

### BACKGROUND

Deep neural networks (DNNs) represent a type of machine learning that utilizes a series of layers to perform designated tasks. Layers of a neural network include interconnected nodes that transfer data from layer to layer. A node, also referred to as a neuron, is a computational unit that implements an activation function. A node in a layer of a neural network sums one or more weighted input connections and employs an activation function that performs a calculation with respect to the combined input. The node outputs a result of the calculation, which itself may feed into other nodes in another layer of the neural network.

Floating-point computations and fixed-point computations may be employed when implementing a neural network. Floating-point computations may be more accurate relative to fixed-point computations but require more time and processing cycles to complete. Thus, to accelerate computations in a DNN, floating-point inputs are converted to fixed-point data (e.g., 8-bit or 16-bit numbers) appropriate for the hardware operating on the data, to allow layers of the DNN to perform fixed-point computations. Fixed-point output of the DNN may be converted back to floating-point data to form a floating-point output of the DNN.

Problematically, the process of converting floating-point numbers to fixed-point numbers (and back again) in the context of artificial neural networks can cause an over-saturation or an under-saturation of the data being processed by the layers of the network. More specifically, the activation functions of a neural network typically output values within a particular range of numbers. Oversaturation occurs when a range of possible outputs for an activation function are underutilized, while undersaturation occurs when the output data breaches or is otherwise clustered at a top-end of the range.

One specific example of an activation function is rectified linear unit (ReLU). ReLU is an activation function that activates a respective node if the summed weighted input of the node is greater than zero. If the summed weighted input is greater than zero, the node activates and transmits the summed weighted input as output. Alternatively, if the summed weighted input is less than zero, the node does not activate and transmits a zero as output. ReLU6 is a modification of the ReLU activation function that limits the activation of a node to a maximum of six, meaning, the output of a node that implements ReLU6 ranges from zero (0) to six (6). ReLU6 output data is undersaturated when some of its values exceed six. ReLU6 output data is oversaturated when its values underutilize the range of possible values (e.g., when all output values fall between zero and four).

Whether data output by an activation function is undersaturated or oversaturated is related to the scaling factor(s) used to convert data between floating-point and fixed-point numbers. Presently, a first scaling factor is used to convert floating-point numbers to fixed-point numbers, while a second scaling factor is used to convert fixed-point numbers to floating-point numbers. The first scaling factor is determined based on the maximum value of the weights for a given layer of a neural network, as well as the size (or type) of the fixed-point numbers that are desired. In addition, the second scaling factor relates to a shift operation (9-bit or 10-bit shift) that is used to convert fixed-point numbers to floating-point numbers.

Unfortunately, determining the first scaling factor in this manner, combined with which type of shift operation is used, results in oversaturated or undersaturated data in the context of ReLU6 implementations. For example, using the first scaling factor and a 9-bit shift results in over-saturated data, which causes a loss of fidelity or resolution in the data. In addition, using the first scaling factor with a 10-bit shift results in under-saturated data, which requires an additional clipping operation to fix.

### SUMMARY

Technology is disclosed herein that improves how scaling factors are determined in the context of artificial neural networks, thereby mitigating or avoiding the need for expensive clipping operations, while also preserving the resolution of data in a neural network. Various implementations include a computer implemented method for determining the scaling factors for a neural network that satisfy the activation function of a respective node. Processing circuitry of a suitable computer determines a saturation point of an activation function. Next, the processing circuitry determines a scaling factor for an output feature map based on the saturation point of the activation function. Then, the processing circuitry determines a scaling factor for an accumulator based on the scaling factor for the output feature map and a shift value related to a quantization. Finally, the processing circuitry determines a scaling factor for a weight map based on the scaling factor for the accumulator.

This Summary is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a software architecture, according to some embodiments.

FIG. 2 illustrates a method for determining a scaling factor, according to some embodiments.

FIG. 3 illustrates a deep neural network (DNN), according to some embodiments.

FIG. 4 illustrates an example software architecture, according to some embodiments.

FIG. 5 illustrates an example component diagram, according to some embodiments.

FIGS. 6A-6B illustrate an operational scenario, according to some embodiments.

FIG. 7 illustrates exemplary result data, according to some embodiments.

FIG. 8 illustrates a computing system suitable for implementing the various operational environments, architectures, processes, scenarios, and sequences discussed below with respect to the other Figures.

### DETAILED DESCRIPTION

Various implementations are disclosed herein that describe improvements to the determination of scaling factors used to scale data in a deep neural network (DNN). The disclosed technique(s) allow for the use of fixed-point computations while mitigating or entirely avoiding oversaturation and undersaturation of the data. In various implementations, a suitable computing system employs a method to determine scaling factors that meet the requirements of the activation functions employed by the nodes of the DNN. The method is implemented in program instructions in the context of software stored on and executed by components of the computing system. Although this disclosure describes processes being performed in software, some or all of these processes may be performed by hardware such as processing circuitry, logic circuitry, digital circuitry, and/or analog circuitry.

When the instructions are executed by processing circuitry, the software directs the computing system to determine the scaling factors for the output feature maps, the accumulators, and the weight maps utilized by the nodes of the DNN that implement fixed-point computations. Scaling factors of the nodes are determined based on characteristics of the DNN. For example, characteristics of the DNN may include a data type of the fixed-point computations, a saturation point of the activation function, or a shift value related to the quantization.

In an embodiment, processing circuitry described herein determines a saturation point of an activation function employed by a respective node of a deep neural network (DNN). Activation functions are mathematical functions used in neural networks to govern the flow of inputs. More specifically, activation functions determine if the summed weighted input of a node meets the requirements to form an output. For example, rectified linear unit (ReLU) is an activation function that activates a respective node if the summed weighted input is greater than zero. If the summed weighted input is greater than zero, the node activates and transmits the summed weighted input as output, else the node transmits a zero. ReLU6 is a modification of the ReLU activation function that has a saturation point of six. Meaning, a node that implements ReLU6 activates if the summed weighted input is greater than zero but requires the transmitted output to be less than or equal to six.

Upon determining the saturation point of the activation function, the processing circuitry determines a scaling factor for an output feature map based on the saturation point of the activation function. The output feature map describes the output of a respective node. In an implementation, the output feature map may be a map storing red-green-blue (RGB) values representative of a convolved image. The scaling factor for the output feature map is representative of a scaling value used to transform fixed-point data to floating-point data.

In some embodiments, the scaling factor for the output feature map is based on the saturation point of the activation function and a data type used by the DNN to perform fixed-point computations. The data type of the DNN describes both the size of the data as well as the type (i.e., signed or unsigned data). If the data type used to perform fixed-point computations employs signed data, the scaling factor for the output feature map can be derived from the following equation:

$$SO = \frac{{2}^{n - 1}}{s}$$

Such that, n=size of the data and s=saturation point. Alternatively, if the data type used to perform fixed-point computations employs unsigned data, the scaling factor for the output feature map may be derived from:

$$SO = \frac{{2}^{n}}{s}$$

Such that, n=size of the data and s=saturation point. Where the size of the data, for both signed and unsigned data, may be representative of 8-bit, 16-bit, or 32-bit data.

In response to determining the scaling factor for the output feature map, the processing circuity determines a scaling factor for an accumulator based on the scaling factor for the output feature map and a shift value related to a quantization. The accumulator is representative of a map that stores computational data of a DNN layer. Typically, computational data is too large to perform optimal fixed-point computations and thus must be quantized to satisfy the hardware of the DNN. The shift value related to the quantization describes the number of bits the computational data must be shifted to continue to perform fixed-point computations. In some examples, the shift value related to the quantization is dependent on the limitations of the hardware accelerator associated with the DNN. In an embodiment the shift value related to the quantization is a power of two number (e.g., 2⁹, 2¹⁰).

Upon determining the scaling factor for the accumulator, the processing circuitry determines a scaling factor for a weight map based on the scaling factor for the accumulator. The weight map is representative of a map that corresponds to a node of the DNN that stores predetermined weights. Weights of a weight map are derived during the training phase of a DNN and are represented as floating-point numbers. The scaling factor for the weight map is used to convert the floating-point weights to fixed-point numbers.

In an embodiment, the scaling factor for the weight map is derived based on the scaling factor for the accumulator and a scaling factor for an associated input feature map. The input feature map is representative of a map that stores data collected by a sensor. For example, the input feature map may store pixel values of an image collected by a camera. In operation, a node of a DNN will receive an input feature map from either an input source (e.g., camera) or a previous node of the network, in the form of floating-point data. The scaling factor for the input feature map is used to convert the received floating-point data to fixed-point numbers to perform computations. Further, the scaling factor for the input feature map allows the processing circuitry to derive the scaling factor for the weight map.

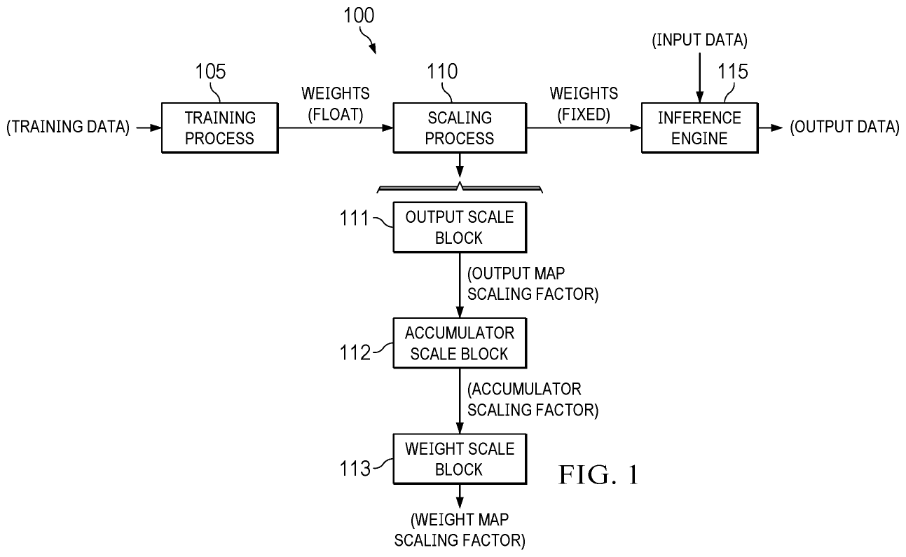

Referring now to the drawings, FIG. 1 illustrates an exemplary software architecture for determining the scaling factors required by respective nodes of a DNN, herein referred to as software architecture 100. Software architecture 100 includes training process 105, scaling process 110, and inference engine 115. Software architecture 100 may be implemented in the context of program instructions, employed by a computing system to determine the scaling factors for respective data employed by respective nodes of the DNN. The functionality of software architecture 100 may be performed by processing circuitry including any combination of integrated circuitry, discrete logic circuitry, analog circuitry, such as one or more microprocessors, microcontrollers, digital signal processors, application specific integrated circuits, central processing units, graphics processing units, field-programmable gate arrays, and/or any other processing resources.

Training process 105 is representative of software used to train layers of a DNN. Layers of the DNN include a series of interconnected nodes, each requiring a respective weight. Training process 105 can be employed offline to determine the floating-point weights that enable the nodes of the DNN to perform a task. For example, a DNN may be tasked to detect facial expressions, track eye movements, recognize speech, and so on. To do so, training process 105 sends training data through a learning framework to determine which weights best enable the DNN to perform the task. In an implementation, training data may include image data, video data, audio data, or a combination thereof. As a result, training process 105 outputs the appropriate floating-point weights to perform the designated task. Output of training process 105 is delivered to scaling process 110.

Scaling process 110 is representative of a process to determine the appropriate scaling factors to allow fixed-point computations, while simultaneously meeting the requirements of an activation function implemented by a respective node. Scaling process 110 includes output scale block 111, accumulator scale block 112, and weight scale block 113. Scaling process 110 may be implemented offline, prior to execution of the DNN.

Output scale block 111 is representative of a software block that determines the scaling factors for the output feature maps produced by the nodes of the DNN. The output feature map is representative of a map that stores fixed-point data produced by a respective node of the network. The scaling factor for the output feature map converts fixed-point data to floating-point data to form an output. Output scale block 111 determines the scaling factor for an output feature map based on a saturation point of an activation function employed by a respective node of the network, and a data type to perform the fixed-point computations. The scaling factors for the output feature maps are used to derive the scaling factors for the associated accumulators.

Accumulator scale block 112 is representative of a software block that determines the scaling factors for the accumulators utilized by the respective nodes of the DNN. The accumulator is representative of a map that stores computational data of a node. Typically, computational data of a node has to be quantized in order to form an output. In operation, a shift operator is used to quantize the data in hardware. Accumulator scale block 112 determines a scaling factor for an accumulator based on the scaling factor for an associated output feature map and the shift value used to quantize the data of the respective node. The scaling factors for the accumulators are used to derive the scaling factors for the associated weights.

Weight scale block 113 is representative of a software block that determines the scaling factors for the weight maps employed by the nodes of the DNN. Each node of the network applies a respective weight to its received input to form a weighted output. As computations are performed in hardware, floating-point weights produced by training process 105 must be converted to a fixed-point format. Floating-point weights are converted to a fixed-point format via scaling factors derived by weight scale block 113. As each node employs a different weight, each node requires an appropriate scaling factor to convert floating-point weights to a fixed-point format. Weight scale block 113 determines a scaling factor for a weight map utilized by a node of the DNN based on the scaling factor for a related accumulator and a scaling factor for an associated input feature map.

The scaling factor for the associated input feature map is derived based on the input source related to the input feature map and the data type used to perform the fixed-point computations. For example, a node may receive an input feature map from a sensor, such as a camera, or from a previous node of the network. Data stored in the input feature map is stored as floating-point values of a specific range, such that the range is determined by the input source. The scaling factor for the input feature map converts the floating-point values to the appropriate fixed-point format to allow fixed-point computations. The scaling factor for the input feature map is derived based on the allowable range of input, and the data type used to perform the fixed-point computations. In an implementation, a node of the network may receive multiple input feature maps from either multiple sensors or previous nodes of the network. As such, weight scale block 113 will determine the multiple scaling factors required for the weight map to satisfy the multiple input feature maps received by the node.

Upon determining the required output feature map scaling factors, accumulator scaling factors, and weight map scaling factors, scaling process 110 may convert the received floating-point weights from training process 105 to fixed-point values. Scaling process 110 outputs the fixed-point weights to inference engine 115 to be applied to the respective nodes of the network.

Inference engine 115 is representative of software used to employ a trained DNN. In an implementation, inference engine 115 receives the necessary scaling factors to apply to the respective nodes of the DNN, such that the requirements of the employed activation functions are satisfied. Each node of the DNN requires one or more input feature map scaling factors, one or more weight map scaling factors, an accumulator scaling factor, and an output feature map scaling factor. Scaling factors required by a node allow the DNN to perform fixed-point computations. In operation, inference engine 115 receives input data from a source, such as a camera, and inputs the data to the DNN. The DNN sends the data through an inference framework to generate an output.

For example, a node of a DNN first receives one or more input feature maps storing floating-point data from an input source. Floating-point data of the input feature maps is converted to fixed-point data by applying the associated input feature map scaling factor. In an implementation, the associated input feature map scaling factor is determined offline. Next, the node performs a fixed-point computation of the weight data and the input feature map data. Data from the computation is stored in an accumulator. Prior to generating an output, data of the accumulator must be downsized via a shift operation. Downsized data is stored in the output feature map as fixed-point numbers. The scaling factor for the output feature map converts the fixed-point numbers of the output feature map into a floating-point format. Floating-point output of a node is then fed into an activation function to determine the activating state of the node.

In an implementation, where the node employs ReLU6, floating-point output less than zero results in an unactivated node, such that unactivated node transmits a zero. Floating-point output greater than zero but less than or equal to six results in an activated node, such that activated node transmits data. In an implementation, output of a node is transmitted to a next a node of the network. In another implementation, output of the node is representative of the overall output produced by the DNN. As a result of determining the scaling factor for the weight map based on the scaling factor for the accumulator, and the scaling factor for output feature map, the requirements of the employed activation function are met, such that resolution of the inference engine's output is preserved, and no additional clipping operators are required.

In a brief operational scenario, training process 105 is fed training data to determine the floating-point weight values that best train a DNN to perform a task. Training process 105 outputs the floating-point weights to scaling process 110. Scaling process 110 determines the scaling factors required by the nodes of the DNN to convert the floating-point weight values into a fixed-point format that satisfies the respective activation functions of the nodes. Scaling process 110 first employs output scale block 111 to determine the scaling factors for the output feature maps generated by the nodes of the network. The scaling factor for an output feature map converts fixed-point data to floating-point values. Output scale block 111 outputs the generated output feature map scaling factors to accumulator scale block 112. Accumulator scale block 112 determines the appropriate scaling factors for the accumulators of the nodes based on the received output feature map scaling factors. Accumulator scale block 112 outputs the generated accumulator scaling factors to weight scale block 113. Weight scale block 113 determines the appropriate scaling factors for the weights based on the received accumulator scaling factors. The scaling factors for the weights convert the floating-point weight values to an acceptable fixed-point format. Upon the execution of weight scale block 113, scaling process 110 applies the weight map scaling factors to the received floating-point values to generate fixed-point weights. Scaling process 110 outputs the fixed-point weights to inference engine 115, to begin execution of the DNN.

In operation, inference engine 115 receives input from a source in the form of an input feature map storing floating-point values. A predetermined scaling factor is applied to the input feature map to appropriately map the floating-point values to the desired fixed-point format. In an implementation, inference engine 115 offloads the fixed-point data to a hardware accelerator to perform the fixed-point computations. For example, convolutions required by the DNN are performed by the hardware accelerator. Upon executing the DNN, inference engine 115 provides output data to the system. Output data may be representative of a final prediction or classification of the input data supplied to inference engine 115.

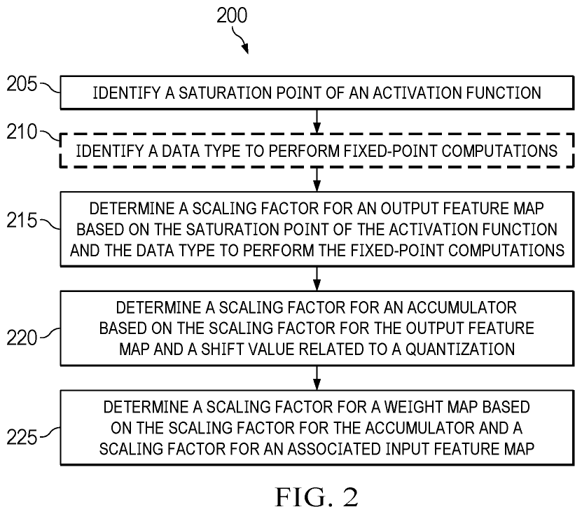

FIG. 2 illustrates a method for determining a scaling factor, herein referred to as method 200. Method 200 may be implemented in the context of program instructions (e.g., scaling process 110) that, when executed by a suitable processing system, direct the processing system to operate as follow, referring parenthetically to the steps in FIG. 2.

To begin, the processing system identifies a saturation point of an activation function implemented by a node of a DNN (step 205). For example, a node that implements ReLU6 will have a saturation point of six. Meaning, the output of the node ranges from zero (0) to six (6). A node that outputs a zero, indicates the node was not activated. Alternatively, a node that outputs a value greater than zero, but less than or equal to six indicates the node was activated.

Next, the processing system identifies a data type of the fixed-point computations associated with the DNN (step 210). For example, a hardware accelerator associated with the DNN may perform fixed-point computations on signed or unsigned data. Further, the accelerator may perform fixed-point computations on either 8-bit, 16-bit, or 32-bit data. Upon identifying the saturation point of the activation function employed by the node, and the data type of the fixed-point computations, the processing system determines a scaling factor for the output feature map produced by the node (step 215). The scaling factor for the output feature map is derived from an equation based on the saturation point of the activation function and the data type to perform the fixed-point computations. In operation, the scaling factor for the output feature map converts fixed-point data to a floating-point format.

In response to determining the scaling factor for the output feature map, the processing system determines a scaling factor for an accumulator based on the scaling factor for the output feature map and a shift value related to the quantization (step 220). In operation, the accumulator stores computational data of the node. Computational data of the node is typically too large to optimally perform fixed-point calculations. Thus, a shift value is used to quantize the computational data to allow fixed-point computations. The scaling factor for the accumulator is based on this shift value, as well as the scaling factor for the output feature map. In an implementation, the scaling factor for the accumulator is derived by determining the product of the scaling factor for the output feature map with the shift value related to the quantization. Additional example details of quantization for neural networks can be found in commonly assigned U.S. Pat. No. 10,878,273, entitled “Dynamic Quantization for Deep Neural Network Inference System and Method,” filed on Jul. 6, 2018, and U.S. Pat. No. 10,824,934, entitled “Methods and Apparatus for Matrix Processing in a Convolutional Neural Network,” filed on Oct. 16, 2017, each of which is incorporated by reference in its entirety.

Upon determining the scaling factor for the output feature map, the processing system determines a scaling factor for a weight map based on the scaling factor for the accumulator and a scaling factor for an associated input feature map (step 225). In an implementation, a node of the network will receive an input feature map with an associated scaling factor. The scaling factor for the input feature map converts floating-point data to a fixed-point format. Further, the scaling factor for the input feature map allows the processing system to derive a scaling factor for the weight map. In an implementation, the scaling factor for the weight map is derived by dividing the scaling factor for the accumulator by the scaling factor for the associated input feature map. If the node receives multiple input feature maps from multiple sources, the processing system determines scaling factors for the weight map based on the scaling factors for each input feature map received. The scaling factor for the weight map converts floating-point weights, determined by the training phase of the DNN, to fixed-point values, to allow fixed-point computations of the DNN.

In an implementation, method 200 is repeated for every node of the network to determine the scaling factors that satisfy the activation functions employed by the nodes. In another implementation, method 200 is repeated for every node of the network that requires fixed-point computations.

Referring back to FIG. 1, the following describes a brief example of method 200 applied in the context of scaling process 110. In operation, scaling process 110 identifies a saturation point of an activation function employed by a node within inference engine 115. Next, scaling process 110 identifies a data type used by an associated hardware accelerator to perform fixed-point computations. Upon determining the saturation point of the activation function as well as the data type, output scale block 111 of scaling process 110 determines the scaling factor for an output feature map produced by the node. Output scale block 111 outputs the determined scaling factor for the output feature map to accumulator scale block 112 of scaling process 110 to determine the scaling factor for an accumulator of the node. The scaling factor for the accumulator is derived based on the scaling factor for the associated output feature map, and a shift value related to a quantization. Accumulator scale block 112 outputs the scaling factor for the accumulator to weight scale block 113 of scaling process 110 to determine the scaling factor for a weight map of the node. The scaling factor for the weight map is derived based on the scaling factor for the accumulator and a scaling factor for an associated input feature map. In an implementation, a node may receive multiple input feature maps. If a node receives multiple input feature maps, weight scale block 113 will determine multiple scaling factors for the weights to be employed by the node. Method 200 is repeated for every node that requires fixed-point computations to determine the appropriate scaling factors that satisfy the activation functions employed by the respective nodes.

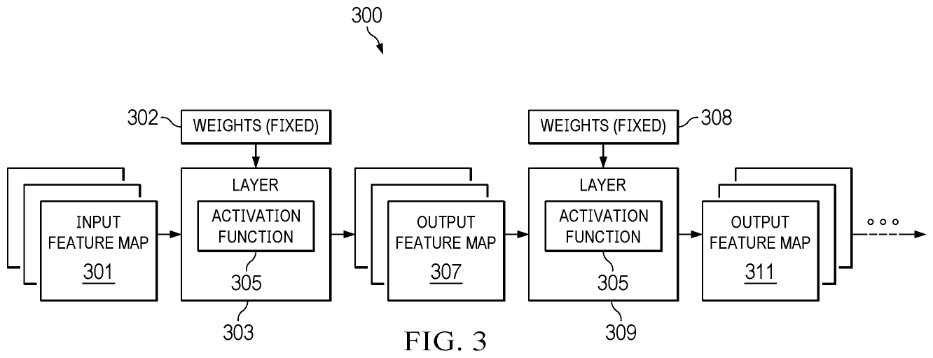

FIG. 3 illustrates a deep neural network (DNN) in which the scaling factors derived by scaling process 110 are employed, herein referred to as DNN 300. DNN 300 is representative of a network that includes a series of layers, where only the first two layers are shown. Specifically, DNN 300 displays layer 303, representative of an input layer, and layer 309, representative of a second layer of the network. Layers of DNN 300 include a series of interconnected nodes that pass data through the layer. Nodes of a layer include activation functions that govern the flow of data within the layer. For example, layer 303 and layer 309 include activation function 305. Activation function 305 determines the activation state of a respective node. Activated nodes transmit output, while unactivated nodes transmit a zero. In an implementation, nodes of DNN 300 implement the same activation function. In another implementation, nodes of DNN 300 implement different activation functions.

Prior to operation, layers of DNN 300 receive a set of fixed-point weights, corresponding to respective nodes within the layer. For example, layer 303 receives fixed weights 302, and layer 309 receives fixed weights 308. In an implementation, fixed-point weights of fixed weights 302 and fixed weights 308 are stored in a matrix, also known as a weight map. Fixed weights 302 and 308 are determined from the application of the appropriate scaling factor, derived by scaling process 110, to the floating-point data gathered in the training process of DNN 300.

In an implementation, layers of DNN 300 receive input from a source such as a camera or a previous layer of DNN 300. Input to a layer is represented as a matrix, herein referred to as a feature map. In an implementation, layers of the DNN may receive multiple feature maps as input. Feature maps store data collected by a sensor. For example, feature maps may store pixel values of an image collected by a camera. In operation, a feature map, such as input feature map 301, is transmitted to a layer of the network, such that the layer produces a corresponding output feature map, such as output feature map 307. The output feature map produced by a layer is representative of a matrix that stores computational data of the layer. In an implementation, the output feature map acts as input to a next layer of DNN 300. In another implementation, the output feature map represents the overall output of DNN 300.

Referring back to FIG. 1, DNN 300 may be implemented in the context of software architecture 100, executed by inference engine 115. Prior to operation, DNN 300 is trained to perform a task via training process 105. Training process 105 feeds training data to DNN 300 to determine which floating-point weight values best enable the nodes of DNN 300 to perform the task. Output of training process 105 is loaded into scaling process 110 to determine the required scaling factors needed by DNN 300 to allow fixed-point computations which satisfy activation function 305. Execution of scaling process 110 results in the conversion of the floating-point weight values generated by training process 105 to the desired fixed-point format. Fixed-point weight values generated by scaling process 110 are applied to the respective nodes of DNN 300. For example, layer 303 receives fixed weights 302, and layer 309 receives fixed weights 308, to be applied to the appropriate nodes of the layer. Further, scaling process 110 determines the required scaling factors to perform computations of DNN 300 in hardware.

In operation, inference engine 115 receives input data from a sensor. Data from the sensor is formatted into a feature map, such as input feature map 301. Input feature map 301 is delivered to an input layer of DNN 300. In a first operation, layer 303 converts the floating-pointdata of input feature map 301 to fixed-point values by applying the appropriate scaling factor. Next, the fixed-point data of input feature map 301 is sent through the nodes of layer 303 to generate output feature map 307. Output feature map 307 is representative of the computational output of layer 303. Computational output of layer 303 is determined by the application of fixed weights 302 to the fixed-point data of input feature map 301. In an implementation, fixed-point computations of layer 303 are executed by a hardware accelerator. Output of the hardware accelerator is converted to floating-point values through the application of a corresponding scaling factor to determine the activation state of a node and/or layer. In an implementation, floating-point values of layer 303 are fed to activation function 305 to determine the activation state of the layer. Dependent on the activation state, activation function 305 generates the corresponding output. In an implementation activation function 305 generates output feature map 307, storing data indicative of an activated layer.

Output feature map 307 acts as input to the next layer of DNN 300 such that the fixed-point data of output feature map 307 is sent through the nodes of layer 309 to generate output feature map 311. Output feature map 311 stores the computational data, generated by the hardware accelerator, and accepted by activation function 305. Output feature map 311 is passed as input to a next layer of DNN 300. Layers of DNN 300 continue to receive and generate output feature maps until a final layer is reached. At the final layer of DNN 300, the generated output feature map represents the overall output of inference engine 115.

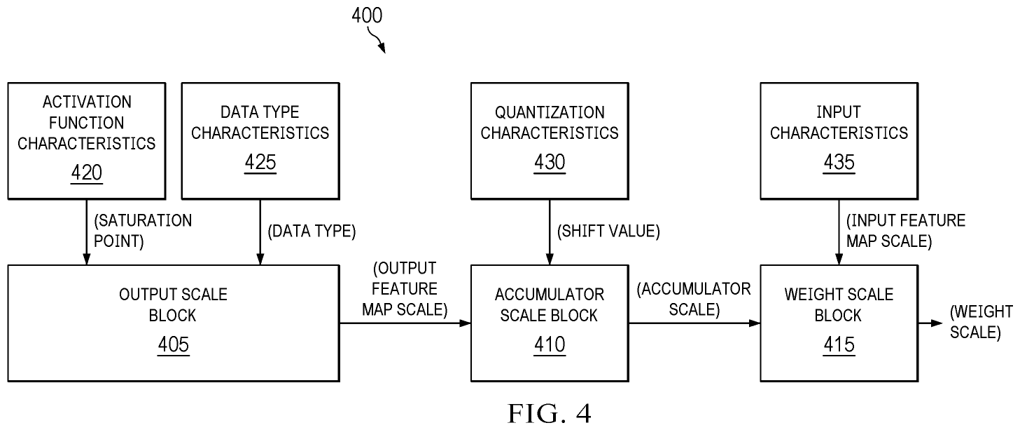

FIG. 4 illustrates a software architecture for implementing a scaling process (e.g., scaling process 110), herein referred to as software architecture 400. Software architecture 400 includes output scale block 405, accumulator scale block 410 and weight scale block 415. In an implementation, software blocks of software architecture 400 gather data from memory to determine the scaling factors required by a DNN to perform fixed-point computations. For example, activation function characteristics 420, data type characteristics 425, quantization characteristics 430, and input characteristics 435 are representative of the data needed to determine the scaling factors for the nodes. Scaling factors generated by software architecture 400 satisfy the activation functions employed by the nodes of the DNN. Software architecture 400 may be implemented in the context of program instructions, employed by a computing system to determine the scaling factors for respective data employed by respective nodes of the DNN.

Output scale block 405 is representative of a software block that determines the scaling factors to convert the output of the nodes from fixed-point numbers to a floating-point format. In an implementation, output produced by the nodes is stored in a matrix, herein referred to as an output feature map. The scaling factor for the output feature map converts fixed-point data of the output feature map to floating-point values. Floating-point values of the output feature map may be used to either, determine the activation state of the node, or form an output of the DNN. The scaling factor for the output feature map is based on characteristics of the DNN. In an implementation, the scaling factor for the output feature map is derived based on the saturation point of the activation function employed by the node, and the data type used to perform fixed-point computations.

Accumulator scale block 410 is representative of a software block that determines the scaling factors for the accumulators of the nodes of the DNN. The accumulators of the nodes store computational data of the fixed-point computations performed in hardware. Generally, computational data of a node is too large to continue fixed-point computations. Thus, a shift operator is used to quantize the computational data in hardware, such that results of the quantization are of an acceptable size. Accumulator scale block 410 determines the scaling factor for an accumulator based on the associated output feature map scaling factor and the shift value related to the quantization.

Weight scale block 415 is representative of a software block that determines the scaling factors for the weights applied by the nodes of the DNN. Prior to operation, a DNN is sent through a learning framework to train the DNN to perform a task. Output of the learning framework is representative of the floating-point weight values required by each node of the DNN. In an implementation, output of the learning framework is stored in a set of matrices, also called weight maps, each corresponding to a respective node of the DNN. Weight scale block 415 generates scaling factors to convert the floating-point values of the weight maps to fixed-point numbers. The scaling factors for the weight maps are derived based on the scaling factor for the associated accumulator, and a scaling factor for an associated input feature map. In an implementation the scaling factors for the input feature maps are determined offline and stored in memory.

Activation function characteristics 420 is representative of memory that stores data related to the activation functions employed by the nodes of the network. Nodes of the network may employ the same or different activation functions, dependent on the requirements of the nodes. In an implementation, activation function characteristics 420 stores the saturation points of the activation functions. For example, a node that employs ReLU6 will have a saturation point of six, a value stored in activation function characteristics 420.

Data type characteristics 425 is representative of memory that stores data related to a hardware accelerator associated with the DNN. For example, a DNN may employ a hardware accelerator to perform fixed-point computations. In an implementation, acceptable data types of the hardware accelerator include signed or unsigned data. Further, the hardware accelerator may perform computations on 8-bit, 16-bit, or 32-bit data.

Quantization characteristics 430 is representative of memory that stores data related to the quantization of the DNN. In operation, computational data of a node must be quantized to form an output. In an implementation, the quantization of data is performed in hardware via a shift operation. Quantization characteristics 420 stores the shift values related to the quantization of data required by respective nodes of the network.

Input characteristics 435 is representative of memory that stores the scaling factors for the input feature maps received by the nodes of the network. In an implementation, the scaling factors for the input feature maps are based on the range of data allowed by an input source and the data type of the fixed-point computations. Input characteristics 435 stores the scaling factors required by the nodes to convert received input to the desired fixed-point format.

In operation, software architecture 400 first executes output scale block 405. Output scale block 405 gathers characteristics of the DNN required to compute the scaling factors for the output feature maps produced by nodes of the DNN. For example, to determine the scaling factor for an output feature map produced by a single node of a DNN, output scale block 405 identifies the saturation point of the activation function employed by the node, and the data type of the fixed-point computations employed by the DNN. Activation function characteristics 420 provides the saturation point of the activation function to output scale block 405. Similarly, data type characteristics 425 provides the desired data type of the fixed-point computations to output scale block 405. In response, output scale block 405 generates the scaling factor for the output feature map produced by the respective node. Output scale block 405 outputs the generated scaling factor to accumulator scale block 410 to begin execution.

In response to receiving the scaling factor for the output feature map, accumulator scale block 410 obtains the shift value related to the quantization from quantization characteristics 430. Upon execution, accumulator scale block 410 generates the accumulator scaling factor required by the node. Accumulator scale block 410 outputs the generated scaling factor for the accumulator of the respective node to weight scale block 415 to begin execution.

Weight scale block 415 receives the accumulator scaling factor to determine the related weight map scaling factor. To do so, weight scale block 415 obtains the one or more input feature map scaling factors corresponding to the node from input characteristics 435. As a result, weight scale block 415 generates the one or more weight map scaling factors for the respective node, such that the number of scaling factors is dependent on the number of input feature maps received by the node.

In an implementation, software architecture 400 is executed for every node of a DNN that utilizes fixed-point computations. As a result, software architecture 400 generates the required scaling factors to allow fixed-point computations that simultaneously satisfy the activations functions of the respective nodes.

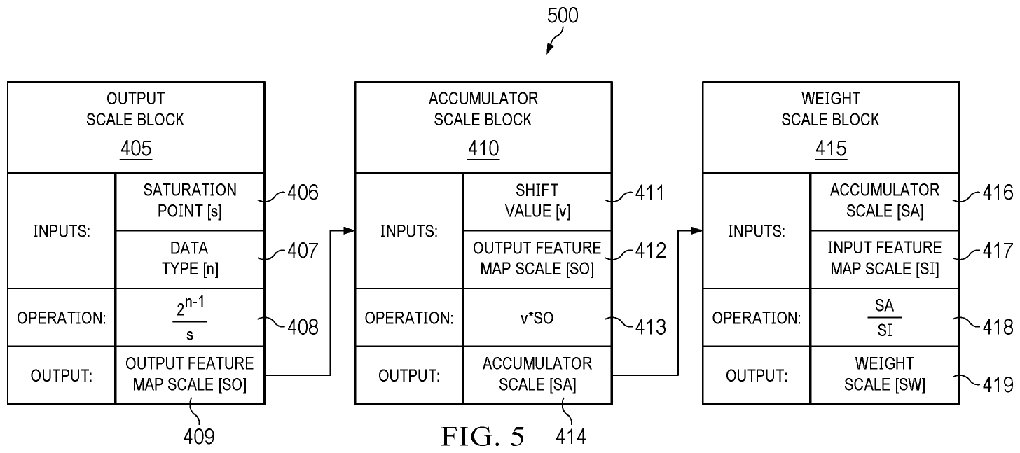

FIG. 5 illustrates component diagram 500, representative of a diagram that details the structures and data throughput of the elements in software architecture 400. Component diagram 500 includes output scale block 405, accumulator scale block 410, and weight scale block 415. Software blocks of software architecture 400 receive inputs to perform an operation that generates an output. Inputs received by the software blocks may be gathered from memory, or representative of an output from another software block. For example, accumulator scale block 410 receives the output of output scale block 405 as input to perform an operation. Software blocks of component diagram 500 perform operations representative of equations used to derive the scaling factors that allow fixed-point computations which satisfy the activation functions of the DNN. Outputs of the software blocks are representative of the results of the operation.

Output scale block 405 determines the scaling factors for the output feature maps generated by the nodes of the network. Inputs to output scale block 405 include saturation point (s) 406 and data type (n) 407. In an implementation, the saturation points of respective nodes and the data type of an associated hardware accelerator are stored in memory. In operation, output scale block 405 gathers the required data from memory to perform operation 408. Operation 408 of output scale block 405 may execute either:

$$SO = \frac{{2}^{n - 1}}{s} \qquad ( 1 )$$

$$SO = \frac{{2}^{n}}{s} \qquad ( 2 )$$

Such that equation (1) is representative of an operation using signed data, while equation (2) is representative of the operation using unsigned data. Output 409 of operation 408 is representative of the scaling factor (SO) required by an output feature map to convert fixed-point data to floating-point values. Output scale block 405 delivers output 409 to accumulator scale block 410 to determine the scaling factor for an associated accumulator.

Accumulator scale block 410 determines the scaling factors for the accumulators required by the respective nodes of the network. Inputs to accumulator scale block 410 include shift value (v) 411 and output feature map scale (SO) 412. In an implementation, the shift values required by the nodes of the network are stored in memory. In operation, accumulator scale block 410 receives the output feature map scaling factor for a node and gathers the corresponding shift value from memory to perform operation 413. In an implementation, operation 413 includes:

SA=SO*v

Such that SO=output feature map scaling factor and v=shift value. Output 414 of operation 413 is representative of the scaling factor (SA) for the accumulator of a node. Accumulator scale block 410 delivers output 414 to weight scale block 415 to determine the scaling factor for one or more associated weight maps.

Weight scale block 415 determines the scaling factors for the weight maps employed by the nodes of the DNN. Inputs to weight scale block 415 include accumulator scale (SA) 416 and input feature map scale (SI) 417. In an implementation, the scaling factors for the input feature maps are determined offline and are stored in memory. In operation, weight scale block 415 receives the accumulator scaling factor for a node and gathers one or more corresponding input feature map scaling factors. Upon gathering the input, weight scale block 415 performs operation 418. In an implementation operation 418 includes:

$$SW = \frac{SA}{SI}$$

Such that SA=accumulator scaling factor and SO=input feature map scaling factor. Output 419 of operation 418 is representative of the scaling factor (SW) for the weight map applied by the node. In an implementation, weight scale block 415 generates multiple outputs corresponding to the number of input feature maps received at the node.

In a brief operational scenario, output scale block 405 gathers saturation point 406 and data type 407 from memory. Next, output scale block 405 performs operation 408 to generate output 409, representative of a scaling factor for an output feature map. Output scale block 405 passes generated output 409 to accumulator scale block 410 as input. Upon receiving output feature map scale 412, accumulator scale block 410 gathers shift value 411 from memory. Next, accumulator scale block 410 performs operation 413 to generate output 414, representative of the scaling factor for the accumulator of the node. Accumulator scale block 410 passes output 414 to weight scale block 415 as input. Upon receiving accumulator scale 416, weight scale block 415 gathers input feature map scale 417 from memory. Next, weight scale block 415 performs operation 418 to generate output 419. Output 419 is representative of the scaling factor required by a node to convert floating-point weight values to the appropriate fixed-point format.

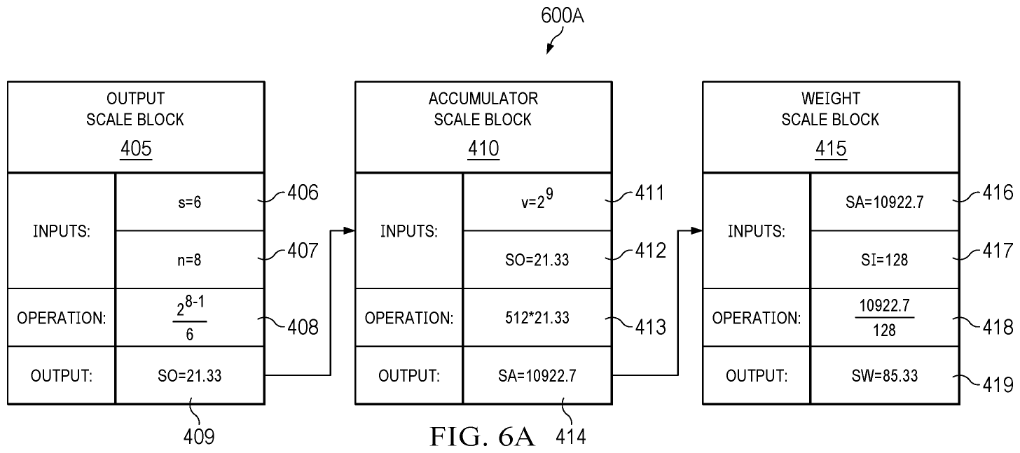

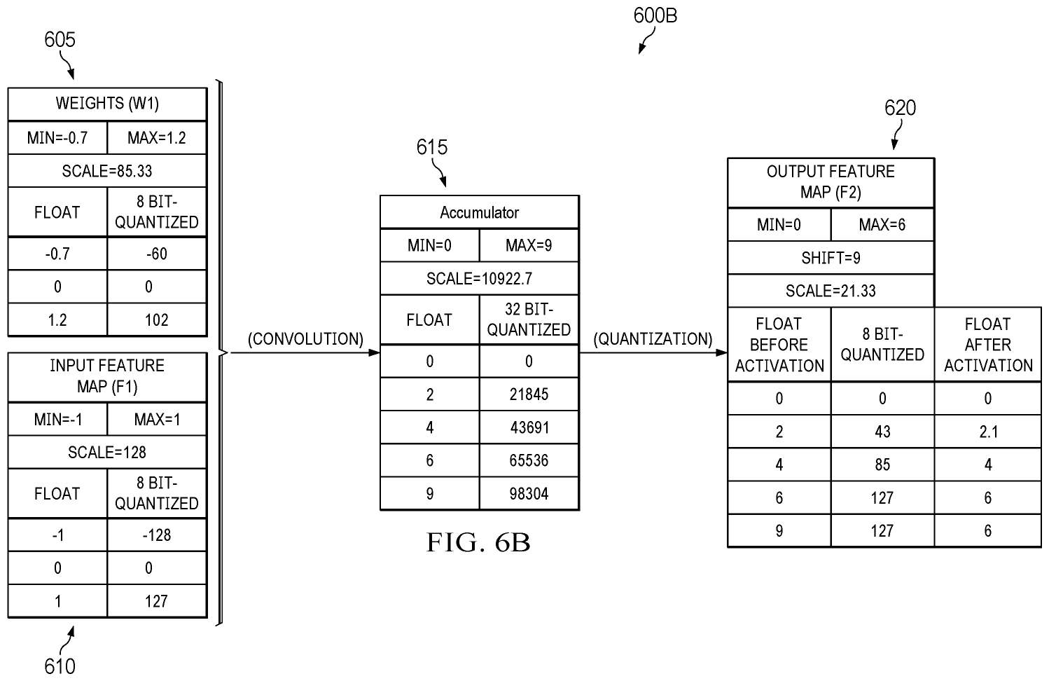

FIGS. 6A and 6B illustrate two stages of an operational scenario, demonstrating an example process for determining and applying scaling factors to a node of a DNN. FIG. 6A illustrates a first stage of the operational scenario in the context of component diagram 500 and software architecture 400, herein referred to as stage 600A. Stage 600A displays the process for determining the scaling factors for a node that employs ReLU6 within a DNN that performs signed 8-bit computations.

In operation, output scale block 405 first gathers saturation point 406 and data type 407 from memory, such that the saturation point is equal to 6 and the data type is representative of signed 8-bit data. Next, output scale block 405 performs operation 408 to determine the scaling factor for the output feature map generated by the node. As computations are performed on signed data, operation 408 executes the following equation:

$$SO = \frac{{2}^{8 - 1}}{6}$$

Such that, the results of operation 408 form output 409 and equal 21.33. Output scale block 405 sends output 409 to accumulator scale block 410 as input.

Accumulator scale block 410 receives output 409, represented as output feature map scale 412. Upon receiving output 409, accumulator scale block 410 gathers shift value 411 from memory, such that the shift value of the node is equal to 512 (e.g., 2⁹). Next, accumulator scale block 410 performs operation 413 to determine the scaling factor for the accumulator. Results of operation 413 form output 414 and equal 10922.7. Accumulator scale block 410 delivers output 414 to weight scale block 415 to begin execution.

Weight scale block 415 receives output 414, represented as accumulator scale 416. Upon receiving output 414, weight scale block 415 gathers input feature map scale 417 from memory. Next, weight scale block 415 performs operation 418 to determine the scaling factor for the weight map of the node. Results of operation 418 form output 419 and equal 85.33. Weight scale block 415 delivers output 419 to the respective node of the DNN.

Now turning to FIG. 6B, stage 600B illustrates a second stage of the operational scenario that employs the scaling factors of stage 600A. Stage 600B includes weight map 605, input feature map 610, accumulator 615, and output feature map 620. In an implementation, stage 600B is representative of the computational results of a node of the DNN.

In operation, the node of the DNN receives input feature map 610 storing floating-point data. Floating-point data of the input feature map is converted to fixed-point numbers via application of the input feature map scaling factor. Application of the input feature map scaling factor converts the data to a format suitable for a hardware accelerator to perform computations.

Upon converting the data of input feature map 610, the node offloads the fixed-point data of weight map 605 and input feature map 610 to a hardware accelerator to perform computations required by the DNN. For example, the hardware accelerator may perform a convolution of weight map 605 with input feature map 610.

Results of the convolution are stored in accumulator 615. Typically, results of a convolution must be downsized to return back to the data type accepted by the hardware accelerator. For example, the convolutional results of weight map 605 and input feature map 610 result in a 32-bit number. In order to return back to 8-bit data, the hardware accelerator quantizes the data via a 9-bit shift operation. Output feature map 620 stores results of the quantization.

Currently, data of output feature map 620 is stored as fixed-point numbers and must be converted back to floating-point values to determine the activation state of the node. Data of output feature map 620 is converted back to floating-point values via an application of the output feature map scaling factor (i.e., 21.33). Floating-point values of output feature map 620 are fed to the node's activation function (i.e., ReLU6) to determine the output of the node. If output feature map 620 contains floating-point values all less than zero, the node does not activate, and transmits a zero as output. Else, the node activates and forms an output. It should be noted, due to the process demonstrated in stage 600A, floating-point values of output feature map 620 will always be less than or equal to six. Thus, ReLU6 is always satisfied.

In another example, using the same floating-point input data, the scaling factor for output feature map 620 may be determined based on the scaling factor for accumulator 615 and a shift value related to the quantization. In this example, the scaling factor for accumulator 615 is based on the scaling factor for weight map 605 and the scaling factor for input feature map 610. In an implementation, the scaling factors for weight map 605 and input feature map 610 may be derived based on the range of the floating-point values of each map as well as the data type to perform the quantization. As shown in weight map 605, the floating-point data ranges from negative 0.7 to positive 1.2, while the floating-point data of input feature map 610 ranges from negative 1 to positive 1. In an implementation, where the data type to perform the quantization is signed 8-bit data, the scaling factor for weight map 605 may be determined by dividing the maximum 8-bit signed value (i.e., 128) by the maximum floating-point weight value (i.e., 1.2). As a result, the scaling factor for weight map 605 equals 106.7. Similarly, the scaling factor for input feature map 610 may be determined by dividing the maximum 8-bit signed value by the maximum floating-point input value (i.e., 1). As a result, the scaling factor for input feature map 610 equals 128.

In this example, the scaling factor for accumulator 615 may be determined by multiplying the scaling factor for weight map 605 (i.e., 106.7) with the scaling factor for input feature map 610 (i.e., 128). As a result, the scaling factor for accumulator 615 equals 13,653.3. In operation, data of accumulator 615 must be quantized to format the data to an acceptable size. In an implementation the quantization is performed in hardware via a shift operation. For example, hardware associated with the DNN may perform either a 9-bit shift or a 10-bit shift of the data. As a result, the scaling factor for output feature map 620 may be determined by dividing the scaling factor for accumulator 615 by the maximum shift value (e.g., 512 or 1024).

In an implementation where hardware associated with the DNN performs a 9-bit shift, the scaling factor for output feature map 620 equals 26.7. In operation, the scaling factor for output feature map 620 converts fixed-point data to floating-point values. As a result of determining the scaling factor for output feature map 620 based on the scaling factor for accumulator 615 and the maximum value of the 9-bit shift, the floating-point values of output feature map 620 are oversaturated. In another implementation where hardware associated with the DNN performs a 10-bit shift, the scaling factor for output feature map 620 equals 13.3. As a result of determining the scaling factor for output feature map 620 based on the scaling factor for accumulator 615 and the maximum value of the 10-bit shift, the floating-point values of output feature map 620 are undersaturated. It should be noted, the method provided in this example is representative of previous methods to obtain scaling factors required by a DNN that utilizes hardware to perform computations. Further, the method provided in this example results in undersaturated or oversaturated output data, dependent on the shift operation used. The techniques of this disclosure can be implemented to reduce the likelihood and/or magnitude of undersaturation and oversaturation.

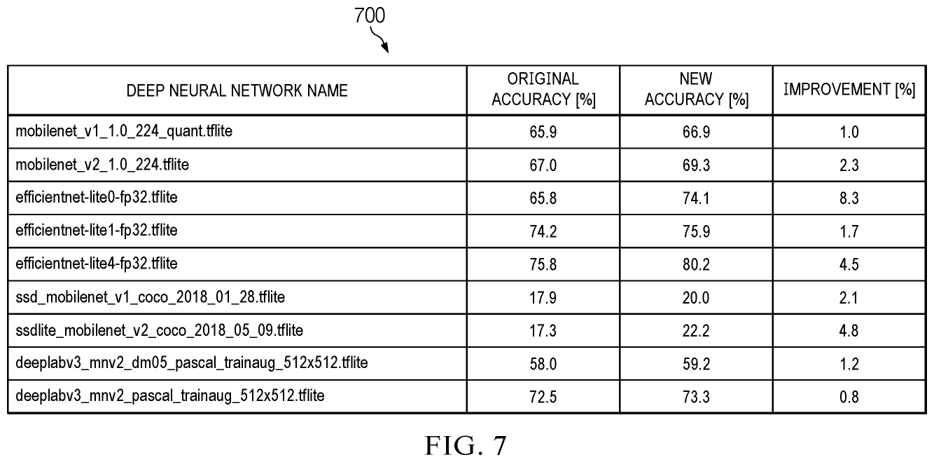

FIG. 7 illustrates an exemplary results table, herein referred to as table 700. Table 700 depicts the difference in accuracy of DNNs that implement the method described herein, as opposed to when alternative methods are used. The accuracy of a DNN describes the DNN's ability to perform a required task.

On average, DNNs that employed the method for determining scaling factors that satisfy the activation function of a respective node improved the accuracy of the DNN by a factor of 3%. On the high end, row 3 of table 700 displays an 8.3% improvement, while on the low end, row 9 of table 700 displays a 0.8% improvement. The improvements shown are exemplary data but stand to show that implementation of the present algorithms provide a technical improvement over prior systems.

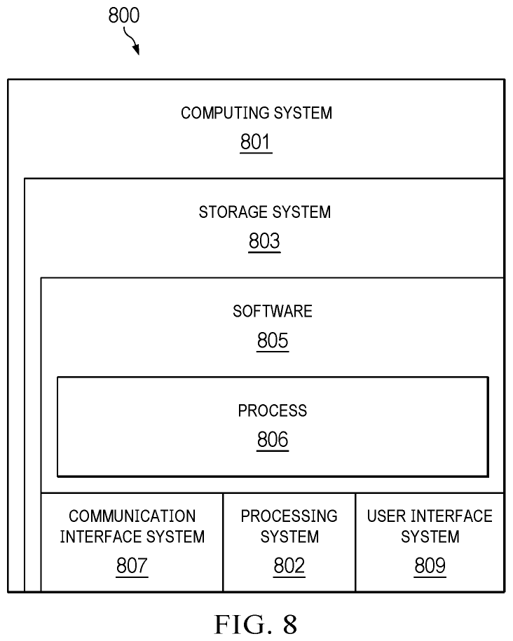

FIG. 8 illustrates computing system 801 that represents any system or collection of systems in which the various processes, programs, services, and scenarios disclosed herein may be implemented. Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809 (optional). Processing system 802 is operatively coupled with storage system 803, communication interface system 807, and user interface system 809.

Processing system 802 loads and executes software 805 from storage system 803. Software 805 includes and implements process 806, which is (are) representative of the processes discussed with respect to the preceding Figures, such as method 200. When executed by processing system 802, software 805 directs processing system 802 to operate as described herein for at least the various processes, operational scenarios, and sequences discussed in the foregoing implementations. Computing system 801 may optionally include additional devices, features, or functionality not discussed for purposes of brevity.

Referring still to FIG. 8, processing system 802 comprises a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, application specific processors, and logic devices, as well as any other type of processing device, combinations, or variations thereof.

Storage system 803 comprises any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 (including process 806) may be implemented in program instructions and among other functions may, when executed by processing system 802, direct processing system 802 to operate as described with respect to the various operational scenarios, sequences, and processes illustrated herein. For example, software 805 may include program instructions for implementing process as described herein for identifying scaling factors.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing system 801 is representative) overall from a general-purpose computing system into a special-purpose computing system customized to support the execution of inference models in an optimized manner. Encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

It may be appreciated that, while the inventive concepts disclosed herein are discussed in the context of such productivity applications, they apply as well to other contexts such as gaming applications, virtual and augmented reality applications, business applications, and other types of software applications. Likewise, the concepts apply not just to electronic documents, but to other types of content such as in-game electronic content, virtual and augmented content, databases, and audio and video content.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A method comprising:
identifying a saturation point of an activation function;
determining a scaling factor for an output feature map based on the saturation point of the activation function;
determining a scaling factor for an accumulator based on the scaling factor for the output feature map and further based on a shift value related to a quantization, and
determining a scaling factor for a weight map based on the scaling factor for the accumulator.

2. The method of claim 1, wherein the weight map comprises floating-point data, and wherein the method further comprises converting the floating-point data to fixed-point data using the scaling factor for the weight map.

3. The method of claim 1, wherein the activation function comprises a rectified linear activation function.

4. The method of claim 3, wherein the saturation point of the rectified linear activation function is six.

5. The method of claim 1, wherein the shift value related to the quantization is representative of a power of two number.

6. The method of claim 1, further comprising identifying a data type to perform fixed-point computations, wherein determining the scaling factor for the output feature map is further based on the data type to perform the fixed-point computations.

7. The method of claim 6, wherein the data type comprises data represented as one of: signed 8-bit numbers and or signed 16-bit numbers.

8. The method of claim 1, wherein determining the scaling factor for the weight map is based on the scaling factor for the accumulator and further based on a scaling factor for an associated input feature map.

9. The method of claim 1, wherein identifying the saturation point occurs during training of a neural network.

10. A computing apparatus comprising:
one or more computer-readable storage media;
one or more processors operatively coupled with the one or more computer-readable storage media; and
program instructions stored on the one or more computer-readable storage media that, when executed by the one or more processors, direct the computing apparatus to at least:
identify a saturation point of an activation function;
determine a scaling factor for an output feature map based on the saturation point of the activation function;
determine a scaling factor for an accumulator based on the scaling factor for the output feature map and further based on a shift value related to a quantization, and
determine a scaling factor for a weight map based on the scaling factor for the accumulator.

11. The computing apparatus of claim 10, wherein the weight map comprises floating-point data, and wherein the program instructions further direct the computing apparatus to convert the floating-point data to fixed-point data using the scaling factor for the weight map.

12. The computing apparatus of claim 10, wherein the activation function comprises a rectified linear activation function, and wherein the saturation point of the rectified linear activation function is six.

13. The computing apparatus of claim 10, wherein the shift value related to the quantization is representative of a power of two number.

14. The computing apparatus of claim 10, wherein the program instructions, when executed, direct the computing apparatus to:
identify a data type to perform fixed-point computations; and
determine the scaling factor for the output feature map based on the saturation point of the activation function and further based on the data type to perform the fixed -point computations.

15. The computing apparatus of claim 14, wherein the data type comprises data represented as one of: signed 8-bit numbers and signed 16-bit numbers.

16. The computing apparatus of claim 11, wherein the program instructions, when executed, direct the computing apparatus to determine the scaling factor for the weight map based on the scaling factor for the accumulator and further based on a scaling factor for an associated input feature map.

17. A system comprising:
a memory configured to store a weight map; and
a processor coupled to the memory and configured to:
obtain floating-point data from the weight map; and
convert the floating-point data to fixed-point data using a scaling factor for the weight map;
wherein the scaling factor for the weight map was determined based on a scaling factor for an accumulator and a scaling factor for an associated input feature map;
wherein the scaling factor for the accumulator was determined based on the scaling factor for an output feature map and a shift value related to a quantization; and
wherein the scaling factor for the output feature map was determined based on a saturation point of an activation function and a data type to perform fixed-point computations.

18. The system of claim 17, wherein the activation function comprises a rectified linear activation function, and wherein the saturation point of the rectified linear activation function is six.

19. The system of claim 17, wherein the data type comprises data represented as one of: signed 8-bit numbers and or signed 16-bit numbers.

20. The system of claim 17, wherein the shift value related to the quantization is representative of a power of two number.
